(19) United States
(12) Patent Application Publication
(10) Pub. No.: US 2026/0355852 A1
(43) Pub. Date: Nov. 12, 2026

(54) LASER MACHINING HEAD HAVING A LIDAR SENSOR

(71) Applicant: PREOMICS GMBH & CO. KG, Gaggenau (DE)

(72) Inventors: Marcel SCHÄFER, Lichtenau (DE); Jonas WEBER, Neuhausen (DE); Mathias BACH, Pfinztal (DE); Ludwig WEBER, Gernsbach (DE); Christian LOOSE, Gaggenau (DE)

(21) Appl. No.: 19/122,537

(22) PCT Filed: Oct. 19, 2023
(86) PCT No.: PCT/EP2023/079099

§ 371 Date: Apr. 18, 2025

(30) Foreign Application Priority Data
Oct. 19, 2022 (DE) 10 2022 127 449.7

(51) Int. Cl. B23K 26/03; B23K 26/36

(52) U.S. Cl. CPC B23K 26/032; B23K 26/36

(57) ABSTRACT

A laser machining head for machining a workpiece by a laser beam includes: a housing in which a focusing optic for focusing the laser beam is arranged; and at least one lidar sensor for detecting a distance between the laser machining head and an object in a process space; wherein the lidar sensor is attached to the housing on the outside and a beam path of the lidar sensor extends outside of the housing.

### CROSS-REFERENCE TO RELATED APPLICATIONS

The present invention is the national phase entry of International Patent Application No. PCT/EP 2023/079099, filed October 19, 202, which claims priority to Denmark Patent Application No. 102022127449.7, filed Oct. 19, 2022, the entire contents of both are hereby incorporated by reference.

### FIELD OF THE INVENTION

The present disclosure relates to a laser machining head for machining a workpiece by means of a laser beam with at least one lidar sensor for detecting objects in the surroundings.

### TECHNICAL BACKGROUND

When a workpiece is machined using a laser beam, i.e. during laser machining, the laser beam is usually guided along a machining path by means of a relative movement between a laser machining head emitting the laser beam and the workpiece.

Higher laser power in laser cutting and welding allows for ever-higher process speeds, thereby significantly increasing the demands on the open-loop and/or closed-loop control of the machining process and the potential danger due to the high laser power. In particular, the requirements for collision prevention are increasing since the reaction time is decreasing and possible collisions may have more drastic consequences. Therefore, it is advantageous to optically measure the surroundings of the laser machining head in such a way that unforeseen objects can be detected. This means that sensors are needed that scan the space around the laser machining head in a non-contact and three-dimensional manner in order to detect any interfering parts, such as protruding components, different sheet thicknesses or contaminations.

DE 28 29 851 A1 describes an arrangement for measuring the distance between a metallic workpiece and a machining tool by means of capacitive distance sensors which enables the machining of workpieces with an irregular surface and in particular of protrusions extending in parallel to the tool path.

DE 10 2017 201 730 A1 relates to a method of welding and a welding arrangement, wherein a time-of-flight (ToF) detection device is used to detect an observation window on the workpiece that at least partially precedes the welding point.

DE 10 2015 015 651 B3 relates to a monitoring device for a laser machining system with a measuring beam source and a registration unit which detects a portion of the measuring beam reflected by the surroundings. The measuring beam is coupled, coaxially with the machining beam, into a laser machining head such that the measuring beam and the machining beam can be aligned with common positions in the surroundings.

DE 10 2012 212 278 A1 relates to an arrangement for creating bores or weld seams, wherein a distance between the workpiece and the arrangement is detected by means of a coaxial autofocusing unit. The autofocusing unit may comprise an OCT device, a ToF camera or a triangulation unit.

### SUMMARY OF THE INVENTION

It is an object of the present invention to provide a laser machining head with an efficient and versatile device for observing the process space, in particular for observing the three-dimensional process space.

It is a further object of the present invention to provide a laser machining head with a device for observing the process space that also allows for reliable object recognition in the process space at high process or machining speeds.

It is a further object of the present invention to provide a laser machining head with a device for observing the process space that allows for two-dimensional object recognition or two-dimensional detection of obstacles in the process space.

It is a further object of the present invention to provide a laser machining head with a device for observing the process space which, by means of reliable object recognition in the process space, allows for open-loop or closed-loop control of the machining process, in particular for monitoring the machining process and/or for collision prevention.

At least one of these objects is achieved by the subject matter of independent claim 1.

According to one aspect of the present disclosure, a laser machining head for machining a workpiece, in particular a metallic workpiece, by means of a laser beam, comprises: a housing in which an optics for guiding and/or shaping the laser beam, for example a focusing optics for focusing the laser beam, is arranged; at least one lidar sensor for detecting a distance between the laser machining head and an object in a detection space or in a process space; wherein the lidar sensor is attached to the housing on the outside and a beam path of the lidar sensor extends outside of the housing.

According to a further aspect, a method for monitoring a laser machining process comprises the steps of: performing the laser machining process by radiating a laser beam from a laser machining head (e.g. a laser machining head according to one of the embodiments described herein) onto at least one workpiece, in particular a metallic workpiece, the laser machining head and the workpiece being moved relative to one another along a machining path, detecting distance data during the laser machining process by means of at least one lidar sensor arranged on the laser machining head, which scans a first detection space and a second detection space and detects corresponding distance data, wherein the first detection space is at a greater distance from the laser machining head than the second detection space and the lidar sensor detects the distance data of the first detection space with a lower resolution (or with a coarser pixel grid and/or with a lower scanning rate) than the distance data of the second detection space, and determining, based on the detected distance data, whether an obstacle is present in the first detection space and/or in the second detection space in an area along the machining path. The first detection space may also be referred to as the far range and the second detection space as the near range. The lidar sensor may be attached to the laser machining head or to a housing of the laser machining head on the outside and/or a beam path of the lidar sensor may extend outside of the laser machining head or a housing of the laser machining head.

The laser machining head may comprise a control unit configured to carry out the method according to one of the embodiments of the present invention.

In the present disclosure, a process space refers to a space within which the laser machining head can move relative to the workpiece, and in particular a space within which the laser machining head can move relative to the workpiece during the machining process and/or along a machining path specified for the machining process. In other words, the process space is defined with respect to the workpiece, i.e., the workpiece is stationary in the process space. The detection space is the area of the process space that can be detected by the lidar sensor or in which the lidar sensor can detect objects. The detection space is an area of the process space, i.e., the detection space lies in the process space. The detection space may be defined by the mounting height of the lidar sensor on the laser machining head and/or the detection or opening angle of the lidar sensor. The TCP range refers to the area of the process space into which the laser beam can be directed with respect to the laser machining head. For a fixed-optics laser machining head, this may only be the beam path of the laser beam emerging from the laser machining head, i.e., a line that encompasses the tool center point (TCP, also called machining point) or the focal point of the laser beam. In case of a scanner laser machining head, this may be a cone-shaped space determined by the beam deflection properties of the scanning device.

The present disclosure is concerned with three-dimensional (3D) imaging for laser cutting and welding by means of at least one lidar (light-detection and ranging, also known as ladar, laser-detection and ranging) sensor. The lidar sensor may be, in particular, a lidar camera. Specifically, the two subgroups of AMCW (amplitude-modulated continuous-wave, also known as indirect time-of-flight, iToF) and FMCW (frequency-modulated continuous-wave) lidar sensors may be used. According to the invention, the space outside of the immediate machining area or the TCP area is to be measured, for example, to detect objects arranged in the surroundings of the laser machining head. Objects may be obstacles that lie on or in an area around a given machining path for laser machining, i.e. objects that would collide with the laser machining head due to the relative movement between the laser machining head and the workpiece along the machining path. Such obstacles may be protruding sheet metal parts, workpieces or sheets of different thicknesses, contaminations, a clamping device for holding the workpiece, etc. However, objects may also be features of the machined or unmachined workpiece(s) such as a joint edge or a joint between two workpieces (i.e. in the advance); a marking or positioning aid on a clamping or holding device for holding the workpiece, or a marking or positioning aid on the workpiece or lateral contours of the workpiece for the orientation or alignment of the laser machining head; a topography or surface curvature or inclination of the workpiece; or a weld seam or cut edge produced by the laser machining (i.e. in the wake).

The laser machining head according to the invention offers very extensive options for process space observation due to the enormous versatility of the lidar sensor with a single implementation. In particular, this allows for object recognition in areas that can be used for closed-loop process control and/or for a closed-loop control for collision prevention.

The laser machining head or the method according to one of the aspects listed above may include one or more of the following features:

The laser machining head may be a laser machining head for carrying out a machining process, in particular laser cutting, laser separating, laser welding, laser soldering, laser drilling, etc., on the workpiece by means of the laser beam. The workpiece may in particular be a metallic workpiece.

The lidar sensor may be attached to the housing on the outside (i.e. outside of the optical space defined in the housing), preferably in a removable or reversible manner. The lidar sensor may comprise a lidar camera and/or be configured for spatially resolved detection of distances. In other words, the lidar sensor may be configured to detect objects in a three-dimensional detection space. The lidar sensor may be a ToF-based sensor. The lidar sensor may be an FMCW lidar sensor or an AMCW lidar sensor, i.e. the radiation may be periodically modulated in amplitude or frequency. These two techniques are suitable for spatial resolution in the sub-millimeter range.

The lidar sensor may comprise at least one detector and at least one emitter. The detector and the emitter may be spatially adjacent to each other or spatially separated. When the detector and the emitter are spatially separated from one another, the emitter could illuminate detection spaces of different detectors. In other words, a plurality of detectors could share one emitter.

The lidar sensor or the detector may comprise at least one photodiode, a diode array, a CMOS sensor, at least one avalanche photodiode, etc. The lidar sensor or the emitter may comprise a beam source, in particular a laser beam source, a beam source array, a laser beam source array, at least one LED, an LED array, at least one VCSEL, a VCSEL array, etc. The emitter or the beam source may be a laser beam source or a beam source array in the visible, near-infrared or infrared frequency range.

The lidar sensor may further comprise a beam-shaping optics, for example a diffuser, a diffractive element, a wide-angle lens or a modulation optics.

The lidar sensor may further comprise a protective glass and/or a cross-jet device for generating an air curtain to protect against contamination, e.g. from smoke or spatter.

The detection space of the lidar sensor may at least partially be located outside the TCP area and/or include an area of the workpiece surface. In particular, the TCP may be located outside of the detection space of the lidar sensor. The detection space of the lidar sensor may also be located completely outside of the TCP area, i.e. not include the TCP area. The detection space of the lidar sensor may be at least partially or only partially limited by the workpiece surface. The detection space of the lidar sensor may be limited by the detection angle of the lidar sensor and at least partially by the workpiece or the workpiece surface. The detection space of the lidar sensor may be arranged (at least partially) in the advance and/or weak of the laser machining head and/or to the side of the laser machining head. An area of the workpiece to be machined is located in the advance of the laser machining head, while an area of the workpiece that has already been machined is located in the wake.

The lidar sensor may be arranged on the housing in such a way that an optical axis of the lidar sensor and/or a center axis of its detection space form an angle greater than 0° and/or less than 90° with respect to the optical axis of the focusing optics or to a vertical axis, in particular an angle greater than 20°, 30° or 45°.

The lidar sensor may be attached to the housing such that it can be pivoted and/or moved, so that the position of the detection space and/or the optical axis of the lidar sensor is adjustable. The lidar sensor, in particular the emitter and/or the detector of the lidar sensor, may be rotatable about an axis perpendicular to the optical axis of the focusing optics and/or horizontal and/or in parallel to a side of the housing. In other words, the angle of radiation and/or detection of the lidar sensor may be adjustable. The lidar sensor, in particular the emitter and/or the detector of the lidar sensor, may be movable in parallel to the optical axis of the focusing optics and/or in the vertical direction on the housing. In other words, the mounting height of the lidar sensor may be adjustable. The mounting height and the angle of radiation and detection are crucial for the size of the detection space and in particular for the size of a measurement area.

The housing may comprise a guide, e.g. a rail, along which the lidar sensor can be moved. An edge of the housing, e.g. a lower edge, and/or a corner of the housing, e.g. a lower corner, may have a chamfer or a chamfered surface on which the lidar sensor is attached.

The lidar sensor may include a holder. The lidar sensor, i.e. the emitter and/or the detector of the lidar sensor, may be held in the holder. The holder may be attached to the housing in such a way that it can be pivoted and/or moved and/or released and/or rotated. Alternatively or additionally, the emitter and/or the detector may be arranged in the holder such that it can be pivoted and/or moved. The lidar sensor may be motorized and/or automated so as to be pivotable about an axis perpendicular to the optical axis of the focusing optics and/or about a horizontal axis.

A control, e.g. the lidar control or the laser machining head control, may be configured to control the lidar sensor such that it is pivoted back and forth between two positions. In this way, the lidar sensor may, for example, have a first detection space in the far range and a second detection space in the near range. The control system may also be configured to adapt a (lateral and/or axial) resolution of the lidar sensor to the respective detection space. For example, the control system may be configured such that a (lateral and/or axial) resolution of the lidar sensor is lower in the first detection space than in the second detection space.

The lidar sensor may be configured to detect its detection space with different (lateral and/or axial) resolutions. In other words, the (lateral and/or axial) resolution of the lidar sensor may be adjustable. A control, e.g. the lidar control or the control of the laser machining head, may be configured to adjust the (lateral and/or axial) resolution of the lidar sensor.

The laser machining head may comprise a module that contains the at least one lidar sensor and is detachably attached to the housing. The module may be coaxially attached to the housing. The module may have an opening for the beam path of the laser beam, i.e. to allow the laser beam to pass through the center thereof. The module may be attachable between the housing and a nozzle or to a bottom side of the housing. The module may comprise a plurality of, in particular at least four, lidar sensors arranged around the optical axis of the focusing optics. The module may be attached to the housing such that it can be rotated either manually or motorically. Such a rotatable sensor system may reduce a blind spot or dead area around the laser machining head, i.e. an area that cannot be sensed by any lidar sensor. This means that a surround view is possible. The module may include an interface to convey data from the lidar sensor to a laser machining head control (wireless or wired). The module may include an electronic component and/or a module control and/or a lidar control for controlling the at least one lidar sensor and, optionally, other components of the module. The module may comprise a gas port for a cross-jet device. The module may comprise a lower edge with a chamfer or a chamfered lower edge and/or a chamfered corner on which at least one of the lidar sensors is arranged.

The laser machining head may comprise a lidar control for controlling the at least one lidar sensor and/or for evaluating data from the at least one lidar sensor. The lidar control may be configured to generate a distance signal from the detected data of the at least one lidar sensor. The lidar control may be connected to a control of the laser machining head (in a wired or wireless manner) for unidirectional or bidirectional exchange of data or may be integrated into it.

The laser machining head may comprise a plurality of lidar sensors. When the detection spaces of the lidar sensors overlap, the lidar sensors with overlapping detection spaces may be sensitive to different wavelengths (wavelength ranges). For example, filters for different wavelengths (wavelength ranges) may be arranged in front of the detectors of the lidar sensors with overlapping detection spaces and/or the emitters of the lidar sensors with overlapping detection spaces may emit in different wavelengths (wavelength ranges). The lidar sensors with overlapping detection spaces may also be activated alternately, e.g. by a common lidar control of the lidar sensors, which may also be the control of the laser machining head or may be integrated into it. In other words, these lidar sensors may be controlled such that their detection periods and/or their emission or illumination periods do not overlap.

The at least one lidar sensor may comprise a first lidar sensor with a first detection space and a second lidar sensor with a second detection space. The second detection space (near range) may be closer to the laser machining head than the first detection space (far range). The optical axis of the first lidar sensor may form a larger angle with the optical axis of the focusing optics than the optical axis of the second lidar sensor. The optical axis of the first lidar sensor may form an angle between 70° and 110°, in particular about 90°, with the optical axis of the focusing optics. The optical axis of the second lidar sensor may form an angle between 10° and 50°, in particular between 30° and 40°, with the optical axis of the focusing optics. The first detection space may be smaller than the second detection space.

The first sensor may be configured to detect distances in its detection space with a lower (lateral and/or axial) resolution than the second sensor. Alternatively, a control may be configured to control the first and second sensors in such a way that the first sensor detects distances with a lower (lateral and/or axial) resolution than the second sensor. In other words, an area close to the laser machining head may be measured with a higher (axial and/or lateral) resolution than a distant area. For example, no obstacle is to be overlooked in a close area, while in the distance the reaction time is longer and thus less precision is needed.

It may therefore be advantageous to measure obstacles with different measurement grids. Obstacles closer to the laser machining head should be scanned with higher resolution than obstacles further away. At the same time, however, the scanning space for obstacles that are closer no longer needs to be as large as for those that are further away.

The laser machining head may comprise a third lidar sensor with a third detection space, wherein the third lidar sensor is arranged on a front side of the laser machining head, i.e. in the direction of movement of the laser machining head in the process space, and/or a fourth lidar sensor with a fourth detection space, wherein the fourth lidar sensor is arranged on a rear side of the laser machining head. The third detection space may thus be located in the advance of the laser machining head and/or the fourth detection space may be located in the wake of the laser machining head. The fourth lidar sensor may be configured to detect objects with lower (lateral and/or axial) resolution than at least one of the first, second and third lidar sensors.

Thus, different measurement grids in terms of lateral and axial resolution as well as the extent of the space to be imaged may be applied for 3D imaging. Thus, the deep space or far range (>50 cm and <500 cm with respect to the TCP) or a detection space in the wake may be scanned with a coarser, wider grid than the near space or near range (>20 cm and <50 cm with respect to the TCP) or a detection space in the advance.

The laser machining head may comprise a control for performing open-loop and/or closed-loop control of the machining, e.g. based on the distance data detected by the at least one lidar sensor. The control may comprise a lidar control for controlling the at least one lidar sensor and/or for evaluating data or distances detected by the lidar sensor. The control system may be configured to classify an object as critical or non-critical based on the data or distances detected by the lidar sensor. The classification of an object as critical or non-critical may be performed depending on process parameters, e.g., a feed rate or speed of the laser machining head in the process space, a (mechanical and/or sensory) system inertia, a response time, a predetermined machining path, etc. Here, non-critical means that the laser machining head would not collide with the object when moving along a specified machining path, whether due to the position or size of the object. Accordingly, critical means that the laser machining head would collide with the object.

The control system may be configured to take a measure to prevent a collision. The measure may be selected according to a distance of the object classified as critical to the laser machining head, from at least one of: moving around the object, stopping the machining process, turning off the laser beam, and slowing down or stopping a relative movement between the laser machining head and the workpiece.

The resolution requirements may be related to a response space of the laser machining head. This response space is defined by a response time, i.e. the time it takes for the laser machining head or the laser machining system to respond to an obstacle. The response or measure may vary and range from bypassing to deceleration to an emergency stop of the machine. A response also includes the laser beam possibly being shut down or blocked.

The unit may also be used to measure the distance of the cutting nozzle to the top side of the sheet or to contours on the side. Thus, a capacitive distance sensor system could be calibrated in absolute units or even be replaced.

### BRIEF DESCRIPTION OF THE FIGURES

Examples of the disclosure are shown in the figures and are described in more detail below. In the drawings:

FIG. 1 is a schematic diagram of a laser machining head including a lidar sensor and a second lidar sensor, each of which is arranged outside of the laser machining head;

FIG. 2 is a further schematic diagram of the laser machining head including the lidar sensor, the second lidar sensor and a third lidar sensor, each of which is arranged outside of the laser machining head;

FIGS. 3A to 3D show various arrangements of the lidar sensor on the laser machining head;

FIGS. 4A to 4C show various arrangements of a plurality of lidar sensors on the laser machining head; and

FIGS. 5A and 5B show a module which can be attached to the laser machining head and in which at least one lidar sensor is arranged.

### DETAILED DESCRIPTION OF THE FIGURES

In the following, the same reference symbols are used for the same and equivalent elements, unless otherwise noted.

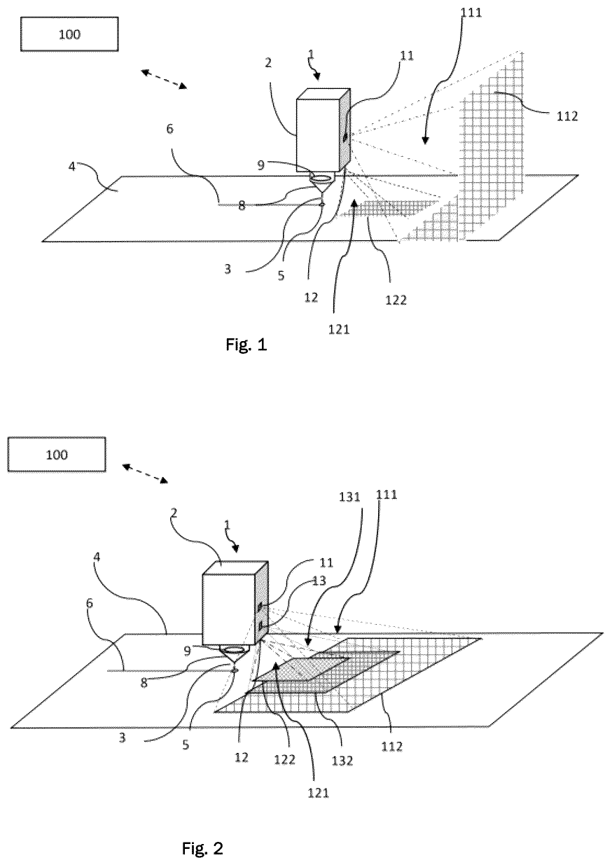

FIG. 1 shows a laser machining head 1 including a housing 2, a focusing optics 9 and a nozzle 8. The focusing optics 9 comprises a lens or a lens group for focusing the laser beam 3. The laser beam then emerges through an opening in the nozzle 8 and hits a machining area or TCP 5 on the workpiece. The machining area 5 may be a cutting kerf 6 in a workpiece 4 or a weld seam 6 between two workpieces 4. Furthermore, a control may be integrated into the laser machining head 1 or connected to the laser machining head 1 by wire or wirelessly. The control 100 is used to control the laser machining head 1 and components thereof and to control the execution of a laser machining process. The control 100 may also control the lidar sensor 11 and/or evaluate the data detected by the lidar sensor.

A (first) lidar sensor 11 is arranged on an outer side of the housing 2, e.g. on the front side in the machining direction. The lidar sensor 11 may detect objects in a first detection space 111 and determine distances to objects in said detection space 111. The lidar sensor 11 may generate a first scanning grid 112 with a predetermined first resolution. The lidar sensor 11 is configured to detect objects in the advance, i.e. objects arranged in front of the laser machining head with respect to the machining direction. The detection space 111 of the first lidar sensor 11 is preferably directed into the space, but may be partially limited by the workpiece 4.

A second lidar sensor 12 may be arranged on a lower edge of the housing 2. The second lidar sensor 12 may detect objects in a second detection space 121 and determine distances to objects in this detection space 121, which is located closer to the laser machining head (near range). The lidar sensor 12 may generate a second scanning grid 122 with a predetermined second resolution. The second resolution may be higher than the first resolution or the second scan grid 122 may be finer than the first scan grid 112. The resolution of the lidar sensor 11 or 12 may also be set accordingly by the control 100.

A center axis of the first detection space 111 (i.e., the center axis passing through the first lidar sensor) forms a larger angle with the optical axis of the focusing optics 9 than a center axis of the second detection space 121. In other words, the second lidar sensor 12 is directed more towards the workpiece or downward than the first lidar sensor 11. The second detection space 121 may be smaller than the first detection space 111. The second detection space 121 and the first detection space 111 may be separated from each other (as shown in FIG. 1) or overlapping (as shown in FIG. 2).

The first lidar sensor 11 and the second lidar sensor 12 may be arranged on the same side of the housing 2, for example, as shown here, on a front side or directed towards the advance. However, the sensors may also be arranged on different sides of the housing 2. Moreover, further lidar sensors may be arranged on the outside of the housing 2. In the examples shown in FIGS. 1 and 2, both detection spaces 111 and 121 are directed towards the advance, i.e. in the machining direction. However, the present disclosure is not limited thereto. For example, the two detection spaces 111 and 121 may also be directed in different directions, e.g. towards the advance and towards the wake.

FIG. 2 shows a further embodiment of the laser machining head 1 with a third lidar sensor 13, which is arranged on an outer side of the housing 2, between the second lidar sensor 12 and the first lidar sensor 11. The third lidar sensor 13 has a third detection space 131 and generates a third scanning grid 132. The first scanning grid 111, the second scanning grid 122 and the third scanning grid 132 may overlap and have a different size or different grids with different sizes.

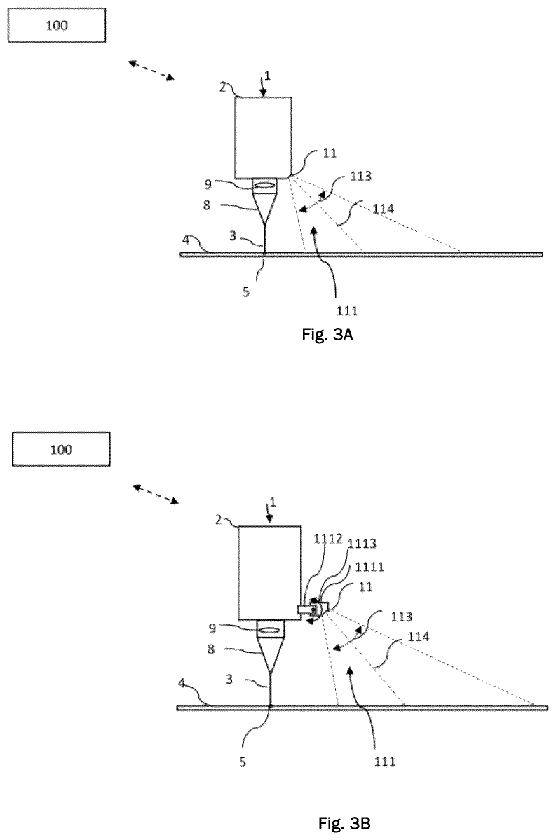

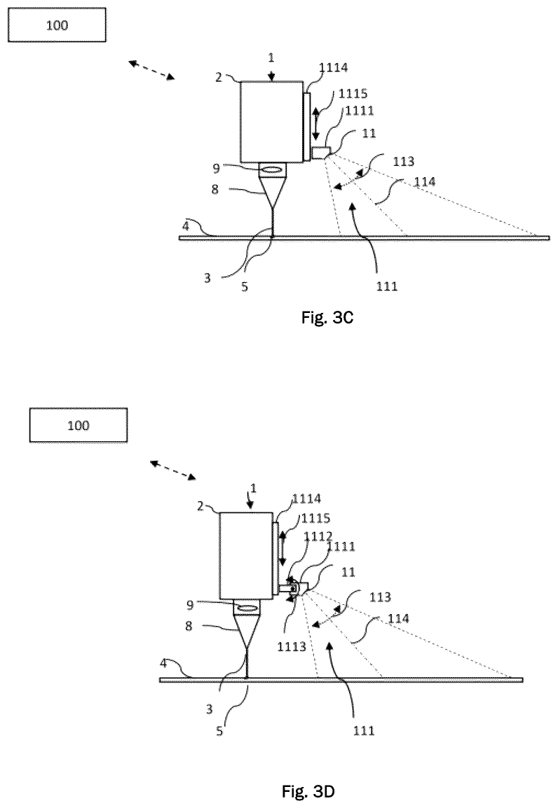

FIGS. 3A to 3D show various arrangements of a lidar sensor on the laser machining head 1. One or more lidar sensors may be provided on the laser machining head 1 according to one or more of the various arrangements shown in FIGS. 3A to 3D. The first, second and/or third lidar sensors of FIGS. 1 and 2, respectively, may be provided on the laser machining head 1 in accordance with one or more of the different arrangements shown in FIGS. 3A to 3D. For reasons of clarity, the lidar sensor is designated 11 in FIGS. 3A to 3D, but this should not be understood as restrictive.

As mentioned above, the lidar sensor 11 has a detection space 111. The detection space 121 is defined by the opening angle or detection angle 113 of the lidar sensor 11 and the position of the lidar sensor on the laser machining head 1 or on the housing 2. An angle bisector of the detection angle 113 forms a center axis 114 of the detection space 111. The center axis 114 of the detection space 111 may correspond to the optical axis of the lidar sensor 11.

FIG. 3A shows a housing 2 of the laser machining head 1 which has a chamfer, i.e. a chamfered edge, on a lower edge. The chamfer may be formed on a lower edge of the housing 2 and/or on a lower corner of the housing 2. The lidar sensor 11 is arranged on the chamfer. In this way, the lidar sensor 11 is oriented obliquely downwards, i.e. directed obliquely onto the workpiece. The detection space 111 may be at least partially limited by the workpiece surface (and the detection angle 113). The housing 2 may have a rectangular cross-section and may have a chamfer on at least two lower edges, with at least one lidar sensor being arranged on each chamfer. The housing 2 may have a rounded cross-section and a circumferential lower edge may be configured as a chamfer all around, with at least one lidar sensor being arranged on said chamfer.

FIG. 3B shows a housing 2 of the laser machining head 1, on the outer side of which a holder 1111 with the lidar sensor 11 attached so as to be rotatable or pivotable. The holder 1111 with the lidar sensor 11 can be rotated about an axis of rotation 1113, which extends horizontally and/or in parallel to the outer side, with respect to the housing 2. The holder 111 with the lidar sensor 11 can be rotated automatically or manually. Therefore, the orientation of the lidar sensor 11 and the detection space 111 of the lidar sensor 11 is adjustable. In particular, an angle between the optical axis of the focusing optics 9 and the workpiece surface and the center axis 114 of the detection space 111 is adjustable. The holder 1111 may additionally have a chamfer on a lower outer edge, on which the lidar sensor 11 may be attached. The holder 1111 may be attached to the housing 2 via a housing holder 1112. The holder 1111 may be rotatably attached to the housing holder 1112.

FIG. 3C shows a housing 2 of the laser machining head 1, on the outer side of which a rail 1114 is attached or integrated. A holder 1111 with the lidar sensor 11 is attached to the rail 1114. The holder 1111 can be moved along the rail 1114 along a vertical and/or horizontal displacement direction 1115. The holder 111 with the lidar sensor 11 can be moved automatically or manually. Thus, the mounting height or position of the lidar sensor 11 or the detection space 111 of the lidar sensor 11 is adjustable. The holder 1111 may additionally have a chamfer on a lower outer edge, on which the lidar sensor 11 may be attached.

FIG. 3D shows an arrangement of the lidar sensor on the housing 2 of the laser machining head 1, in which the arrangements from FIGS. 3B and 3C are combined. The holder 1111 with the lidar sensor 11 is arranged such that it can be moved along the rail 1114 on the outer side of the housing and is additionally rotatable about the axis of rotation 1113 with respect to the housing 2 or the laser machining head.

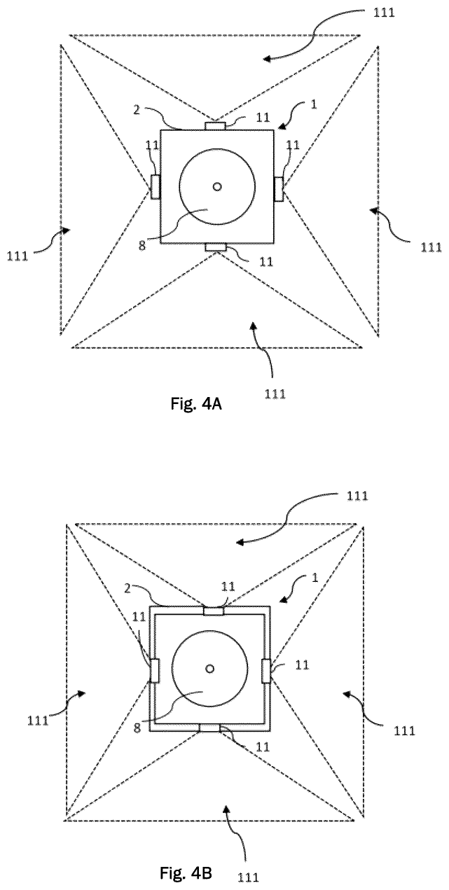

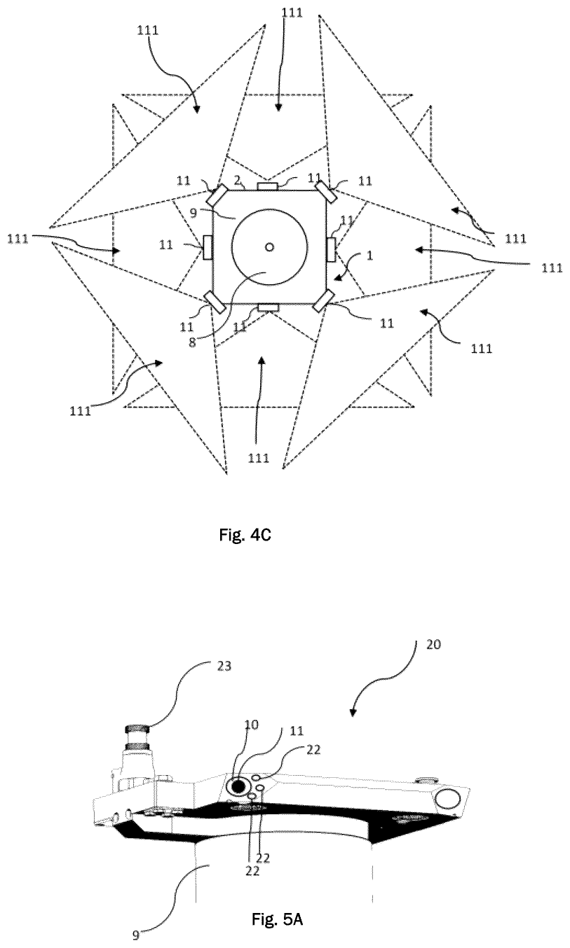

FIGS. 4A to 4C show arrangements of four lidar sensors 11 on the laser machining head 1 and detection spaces 111 thereof. However, there may also be fewer or more than four sensors on the laser machining head. The arrangement on the laser machining head may be as shown in FIGS. 3A to 3C. FIGS. 4A to 4C show the laser machining head 1 from below.

In FIG. 4A, four lidar sensors 11 are arranged on each outer side of the housing 2. In FIG. 4B, four lidar sensors 11 are attached to a chamfered lower edge of the housing. The center axes of the detection spaces of adjacent lidar sensors are each at a 90° angle to one another. With such an arrangement, objects or obstacles in the process space can be detected in all directions. The detection spaces 111 of the lidar sensors 11 may overlap, but this is not necessary.

In FIG. 4C, the laser machining head 1 has an additional lidar sensor 11 at each corner of the housing 2 of the laser machining head 1, in addition to the four lidar sensors 11 arranged as in FIG. 4A or 4B. The center axes of the detection spaces of neighboring lidar sensors are each at a 45° angle to one another. This allows for a surround view.

The lidar sensors 11, which are shown in FIGS. 4A to 4C, may also be arranged in a module 20. The module may be reversibly attached to the housing 2, for example arranged between the housing 2 or the focusing optics 9 and the nozzle 8.

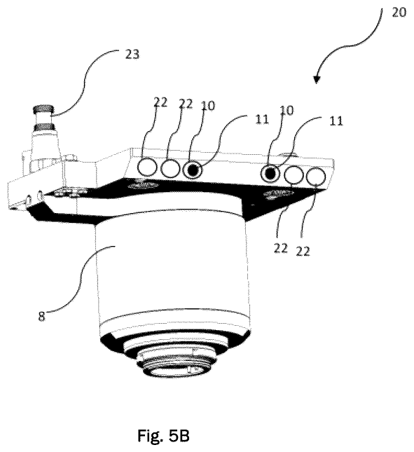

FIGS. 5A and 5B show embodiments of the module 20, which can be attached between the housing 2 and the nozzle 8 and includes at least one lidar sensor 11. Preferably, at least one lidar sensor 11 is arranged on each side of the module 20, for example as shown in FIGS. 4A to 4C.

FIG. 5A shows an embodiment of the module 20 wherein a lidar sensor 11 is arranged at a chamfered corner. The lidar sensor 11 is protected from contamination by a protective glass 10. Furthermore, at least one cross-jet device with at least one ventilation opening 22 may be arranged adjacent to the lidar sensor 11 in order to protect the lidar sensor or the protective glass from smoke residue and other contaminations by means of an air curtain. The cross-jet device is configured to blow a gas, e.g. compressed air, which is supplied through a port 23 of the module, through the ventilation opening 22 over the lidar sensor 11 in a curtain-like manner.

FIG. 5B shows an embodiment of the module 20 wherein two lidar sensors 11 are arranged on one side of the module 20. Of course, only one lidar sensor 11 may be arranged on one side. The module may have a chamfered lower edge on which the lidar sensors 11 are arranged. The lidar sensors 11 may be arranged as shown in FIGS. 4A to 4C. The lidar sensors 11 may be protected from contamination by a protective glass 10 and/or a cross-jet device.

The laser machining head comprises a control 100 for performing open-loop and/or closed-loop control of the machining process, e.g. based on the distance data detected by the at least one lidar sensor 11, 12, 13. The control may comprise a lidar control for controlling the at least one lidar sensor and/or for evaluating data or distances detected by the lidar sensor or may communicate with such a system by wire or wirelessly. The control 100 may be configured to carry out a measure for collision prevention. The control 100 may be configured to classify an object as critical or non-critical based on the data or distances detected by the lidar sensor. The classification of an object as critical or non-critical may be performed depending on process parameters, e.g., a feed speed or speed of the laser machining head in the process space, a (mechanical and/or sensory) system inertia, a response time, a predefined machining path, etc. Here, non-critical means that the laser machining head would not collide with the object when moving along a predetermined machining path-whether due to the position or the size of the object. Accordingly, critical means that the laser machining head would collide with the object. A critical object may be considered to be an obstacle.

The control 100 may be configured to carry out a method for monitoring a laser machining process including the following steps: performing the laser machining process by radiating a laser beam 3 onto the workpiece 4 by means of the laser machining head 1, the laser machining head and the workpiece being moved relative to each other along a machining path, acquiring distance data during the laser machining process by means of at least one lidar sensor 11, 12, 13 arranged on the laser machining head 1, and determining, based on the detected distance data, whether an obstacle or a critical object is present in an area along the machining path. The control 100 of the laser machining head 1 may be configured to carry out the method.

In the step of acquiring distance data, the lidar sensor may scan a first detection space and a second detection space and acquire corresponding distance data, the first detection space being at a greater distance from the laser machining head than the second detection space. The first detection space can also be referred to as the far range and the second detection space as the near range. The lidar sensor may be movably, e.g. rotatably, attached to the laser machining head in order to scan the two different detection spaces. The resolution of the lidar sensor may be adjustable such that the lidar sensor scans the first detection space (far range) with lower resolution than the second detection zone (near range). Alternatively, two lidar sensors may be provided, one for scanning the first detection space and the other for scanning the second detection space. The first lidar sensor for scanning the first detection space may have a lower resolution than the second lidar sensor for scanning the second detection space. The detection space of the lidar sensor or the detection spaces of the lidar sensors are preferably directed towards the advance.

When scanning two different detection spaces, the method may further comprise: determining, based on the detected distance data, whether an obstacle is present in the first detection space in an area along the machining path and/or whether an obstacle is present in the second detection space in an area along the machining path.

The method may further comprise: selecting a measure for collision prevention based on a distance of the obstacle from the laser machining head and based on whether the obstacle is present in the first or second detection space. Examples of measures for collision prevention include: bypassing the object, stopping the machining process, turning off the laser beam, and slowing down or stopping a relative movement between the laser machining head and the workpiece.

The use of at least one lidar sensor, the beam path of which extends outside of the laser machining head and/or the optical axis of which or center axis of the detection space is oriented at an angle with respect to the optical axis of the focusing optics (and/or to the vertical direction) allows for cost-effective, flexible and versatile process monitoring for a machining process.

### LIST OF REFERENCE SYMBOLS

1 Laser machining head
2 Housing
3 Laser beam
4 Workpiece
5 Machining area (TCP)
6 Cutting kerf and/or weld seam
7 Chamfer
8 Nozzle
9 Focusing optics
11 (First) Lidar sensor
112 Scanning grid
113 Detection angle
114 Center axis of the detection space
1111 Holder
1112 Housing holder
1113 Axis of rotation
1114 Rail
1115 Direction of displacement
12 Second lidar sensor
121 Second detection space
122 Second scanning grid
13 Third lidar sensor
131 Detection space of the third lidar sensor
132 Scanning grid of the third lidar sensor
20 Module
21 Protective glass
22 Cross-jets or ventilation openings
23 Gas port
24 Sensor side
100 Control

1. A laser machining head for machining a workpiece by a laser beam, comprising:
a housing in which a focusing optics for focusing the laser beam is arranged; and
at least one lidar sensor for detecting a distance between said laser machining head and an object in a process space;
wherein said lidar sensor is arranged on said housing on the outside and a beam path of said lidar sensor extends outside of said housing.

2. The laser machining head according to claim 1, wherein said lidar sensor is arranged on said housing such that a detection space of said lidar sensor is located at least partially outside of the TCP area and/or includes an area of the workpiece surface.

3. The laser machining head according to claim 1, wherein the optical axis of said lidar sensor and/or the center axis of the detection space forms an angle greater than 0° and/or less than 90° with respect to the optical axis of the focusing optics.

4. The laser machining head according to claim 1, wherein said lidar sensor is attached to said housing so as to be pivotable and/or displaceable such that a position of the detection space and/or the center axis of the detection space and/or the optical axis of said lidar sensor are adjustable.

5. The laser machining head according to claim 1, wherein said housing includes a rail along which said lidar sensor is displaceable and/or includes a lower edge with a chamfer to which said lidar sensor is attached.

6. The laser machining head according to claim 1, wherein said laser machining head comprises a module which includes the at least one lidar sensor and is arranged between said housing and a nozzle of said laser machining head.

7. The laser machining head according to claim 1, wherein said lidar sensor comprises a protective glass and/or a cross-jet device for protection against contamination.

8. The laser machining head according to claim 1, wherein said lidar sensor comprises a ToF-based sensor, AMCW sensor or FMCW sensor, and/or wherein said lidar sensor is configured for spatially resolved detection of distances and/or wherein said lidar sensor is a lidar camera.

9. The laser machining head according to claim 1, wherein the at least one lidar sensor comprises a first lidar sensor having a first detection space and a second lidar sensor having a second detection space, wherein an angle between the center axis of the detection space of said first lidar sensor and the optical axis of said focusing optics is greater than an angle between the center axis of the detection space of said second lidar sensor and the optical axis of said focusing optics.

10. The laser machining head according to claim 9, wherein said first lidar sensor is configured to detect distances with a lower resolution than said second lidar sensor.

11. The laser machining head according to claim 1, wherein said laser machining head comprises a plurality of lidar sensors arranged on opposite sides of said housing and/or circumferentially with respect to the optical axis of said focusing optics on said housing.

12. The laser machining head according to claim 1, wherein said laser machining head comprises a control for performing open-loop and/or closed-loop control of the machining process based on the distance data detected by the at least one lidar sensor and/or for controlling the at least one lidar sensor and/or for evaluating the distances detected by the at least one lidar sensor.

13. The laser machining head according to claim 12, wherein said control is configured to classify the object as critical or non-critical for collision prevention based on the distance detected by said lidar sensor.

14. The laser machining head according to claim 13, wherein said control is configured to carry out a measure for preventing a collision with an object classified as critical and to select the measure, depending on the detected distance, from at least one of the following: bypassing the object, stopping the machining process, turning off the laser beam, and slowing down or stopping a relative movement between said laser machining head and said workpiece.
